(19) United States
(12) Patent Application Publication
(10) Pub. No.: US 2020/0389571 A1
(43) Pub. Date: Dec. 10, 2020

(54) IMAGE PROCESSING METHOD, IMAGE PROCESSING APPARATUS, AND IMAGE PROCESSING PROGRAM

(71) Applicant: Konica Minolta, Inc., Tokyo (JP)

(72) Inventor: Sachiko HIRANO, Tokyo (JP)

(73) Assignee: Konica Minolta, Inc., Tokyo (JP)

(21) Appl. No.: 16/846,449

(22) Filed: Apr. 13, 2020

(30) Foreign Application Priority Data
Jun. 6, 2019 (JP) 2019-105831

(51) Int. Cl. H04N 1/60; H04N 1/00

(52) U.S. Cl. CPC H04N 1/6097; H04N 1/6077; H04N 1/00092; H04N 1/00005

(57) ABSTRACT

An image processing method in a system capable of forming a second image with a second color material on a sheet while forming, as a base, a first image with a first color material on the basis of print data, the method includes: acquiring color information regarding the sheet, the first image, and the second image; and enlarging or reducing an area of the second image protruding from the first image on the basis of the color information regarding the sheet, the first image, and the second image.

The entire disclosure of Japanese patent Application No. 2019-105831, filed on Jun. 6, 2019, is incorporated herein by reference in its entirety.

### BACKGROUND

### Technological Field

The present invention relates to an image processing method, an image processing apparatus, and an image processing program, and more particularly relates to an image processing method, an image processing apparatus, and an image processing program in a system capable of forming a second image with a second color material on a sheet while forming, as a base, a first image with a first color material.

### Description of the Related Art

When a color image is printed on a colored sheet such as color paper, a base image may be formed by using a white toner such that a color of the color image is not affected by a sheet color. At this time, it is known to perform processing of adjusting (referred to as trapping) a printing area such that a printing area of a color image (referred to as a color image area) protrudes from a printing area of a base image (referred to as a base image area) so as to avoid a streak from being visually recognized at a boundary between the images even in a case where a print position (registration) of the base image deviates from that of the color image.

As for this trapping, for example, JP 2016-096447 A discloses an image processing apparatus including: a colored image area extraction means that extracts, on the basis of image information, a colored image area using a plurality of colored materials; a foundation color image area, extraction means that extracts, on the basis of the image information, a foundation color image area laid under the colored image area and using a foundation color material of a predetermined color; a conforming area extraction means that extracts a conforming area having predetermined conformity between the colored image area and the foundation color image area; and an edge correction means that performs, for an edge portion of the colored image area and an edge portion of the foundation color image area of the conforming area, enlargement processing of enlarging the colored image area outward, reduction processing of reducing the foundation color image area inward, or at least one of both the enlargement processing and the reduction processing.

As disclosed in IP 2016-096447 A, processing of enlarging a color image area outward and/or processing of reducing a base image area inward are/is performed in trapping. However, depending on a combination of a sheet color and a print color, there may be a case where a streak tends to be rather visually recognized at a boundary between images after execution of the trapping. This problem occurs not only in a case of using a white toner but also in a case of using a toner of a color other than white in forming the base image. This problem is hardly grasped in advance without actually printing an image on a sheet. To grasp the problem in advance, accurate information regarding a sheet color and all of color materials, and skill are required.

### SUMMARY

The present invention is made in view of the above-described problems and directed to providing an image processing method, an image processing apparatus, and an image processing program which are capable of easily creating a printed matter having a preferable appearance while avoiding a problem that a streak tends to be visually recognized at a boundary between images at the time of trapping.

To achieve the abovementioned object, according to an aspect of the present invention, an image processing method in a system capable of forming a second image with a second color material on a sheet while forming, as a base, a first image with a first color material on the basis of print data, reflecting one aspect of the present invention comprises: acquiring color information regarding the sheet, the first image, and the second image; and enlarging or reducing an area of the second image protruding from the first image on the basis of the color information regarding the sheet, the first image, and the second image.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a schematic diagram that describes trapping in a case of performing color printing on color paper;

FIGS. 2A to 2C are schematic diagrams each illustrating a difference invisibility of a streak at a boundary line between images depending on a combination of a sheet color and a print color;

FIG. 3 is a schematic diagram illustrating an exemplary configuration of a printing system according to an example of the present invention;

FIG. 4 is a schematic diagram illustrating another exemplary configuration of the printing system according to the example of the present invention;

FIGS. 5A and 5B are block diagrams illustrating a configuration of a client terminal according to the example of the present invention;

FIGS. 6A and 6B are block diagrams illustrating a configuration of a controller according o the example of the present invention;

FIG. 7 is a block diagram illustrating a configuration of a printer according to the example of the present invention:

FIG. 8 is a schematic diagram illustrating an overlap between a color image area and a base image area in a case of perforating color printing on color paper;

FIG. 9 is an exemplary screen displayed on the controller according to the example of the present invention;

FIG. 10 is a flowchart illustrating processing of the controller according to the example of the present invention;

FIG. 11 is a flowchart illustrating processing of the controller (determination on a method of changing a trap area) according to the example of the present invention; and

FIG. 12 is a flowchart illustrating processing of the controller (image data correction) according to the example of the present invention.

### DETAILED DESCRIPTION OF EMBODIMENTS

Hereinafter, one or more embodiments of the present invention will be described with reference to the drawings. However, the scope of the invention is not limited to the disclosed embodiments.

As described in the Description of the Related Art, there is a case of forming a base image by using a white toner at the time of printing a color image on a colored sheet such as color paper, and it is known to perform trapping that adjusts a printing area such that a color image area protrudes from a base image area so as to avoid a streak from being visually recognized at a boundary between the images even in a case where a print position of the base image deviates from that of the color image.

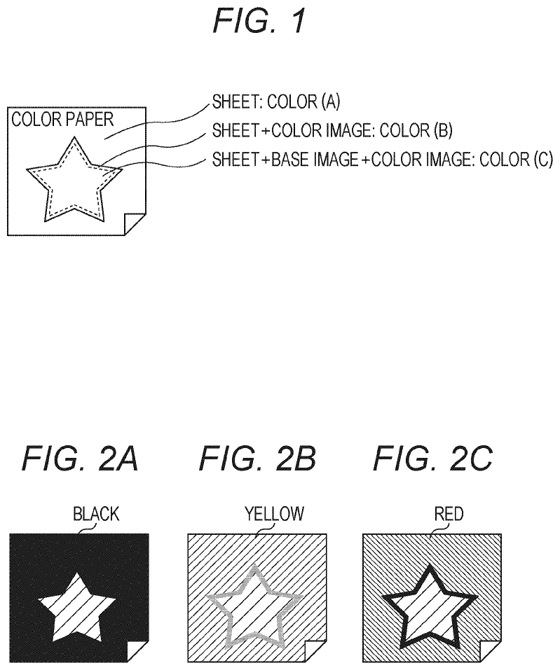

For example, in a case of forming a base image (see a broken line in the drawing) on color paper and forming a color image (see a solid line in the drawing) thereon as illustrated in FIG. 1, the color image is made to protrude from the base image. In this case, an area outside the color image has a color (A) of the sheet, an edge area of the color image (an area having no base image) has a color (B) in combination of the sheet and the color image, and the inside thereof has a color (C) in combination of the sheet, the base image, and the color image. At that time, JP 2016-096447 A discloses a technology in which enlargement processing of enlarging a color image area outward and reduction processing of reducing a base image area inward, or one of both the enlargement processing and the reduction processing are/is performed on the basis of a color relation between “the sheet”, “the sheet+the color image”, and “the sheet+the base image+the color image” in order to improve image quality.

However, depending on a combination of a sheet color and a print color (a color of the color image and a color of the base image), there may be a case where a streak tends to be rather visually recognized at a boundary between the images after execution of the trapping. FIGS. 2A to 2C each illustrate a state of a streak at a boundary of a color image in a case of forming a white base image on each of sheets of various colors and forming a color image (here a light green star-shaped graphic) thereon, and a color difference is indicated by changing a kind of 21) hatching.

For example, as illustrated in FIG. 2A, in a case where a sheet color is black, a relation of brightness between respective areas becomes “the inside of the color image>the edge of the color image≈the outside of the color image”, and there is no inversion in the brightness. Therefore, a streak at the boundary of the color image is not noticeable, which is a preferable result. Also, as illustrated in FIG. 2B, in a case where the sheet color is yellow, the color image has hue close to that of the sheet color, and there is no inversion in the brightness and the saturation. Therefore, the streak at the boundary of the color image is not noticeable, which is an allowable result.

On the other hand, as illustrated in FIG. 2C, in a case where the sheet color is red, the color image has hue far from that of the sheet color. Therefore, the edge of the color image has low brightness and low saturation. As a result, a relation in each of the brightness and the saturation of each area becomes “the inside of the color image>the edge of the color image<the outside of the color image”, and there is inversion in the brightness and the saturation. Therefore, a streak at the boundary of the color image is noticeable, which is a non-preferable result.

This problem may occur not only in a case of using the white toner but also in a case of using a toner of a color other than white in forming the base image, and this problem is hardly grasped in advance without performing actual printing on a sheet. To grasp this problem in advance, accurate information regarding a sheet color and all of color materials, and skill are required.

Considering the above, an embodiment of the present invention is made to solve the new problem that there is a case where a streak tends to be rather visually recognized at a boundary between images after execution of the normal trapping. According to the embodiment, when a base image is formed on a sheet and then a color image is formed thereon, a case that may lead to a non-preferable result after execution of the conventional trapping (area adjustment so as to be “the color image area>the base image area”) is determined from colors of the sheet, the sheet+the color image, and the sheet+the base image+the color image, and settings for trapping (a direction and an area width in enlarging/reducing the area of the color image protruding from the base image) are changed.

Specifically, color information regarding a sheet, a first image, a second Iage is acquired, and an area of the second image protruding from the first image is enlarged or reduced on the basis of the color information regarding the sheet, the first image, and the second image in a system capable of forming the second image with a second color material on the sheet while forming, as a base, the first image with a first color material on the basis of print data. Specifically, whether to enlarge the area or reduce the area is determined on the basis of a relation between: a first color that is a color of the sheet; a second color that is the color obtained when the second image is formed on the sheet with the second color material; and a third color that is a color obtained when the second image is formed with the second color material on the sheet while forming, as the base, the first image with the first color material.

Thus, since the settings for trapping are changed on the basis of the relation between the colors of the sheet, the sheet+the color image, and the sheet+the base image+the color image, a printed matter having a preferable appearance can be easily created while avoiding the problem that a streak tends to be visually recognized at a boundary between the images.

### EXAMPLE

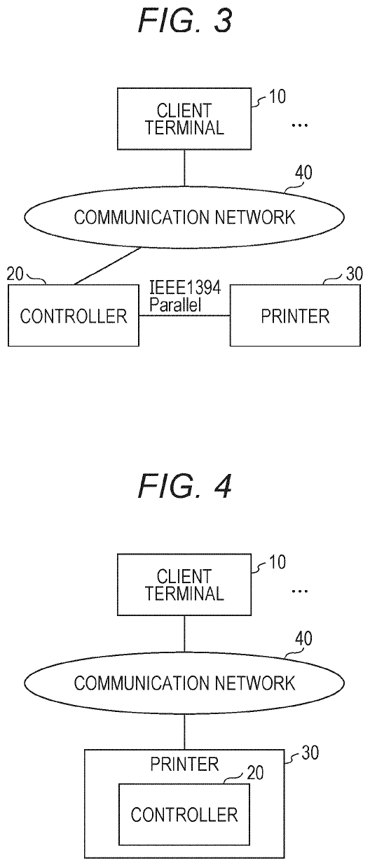

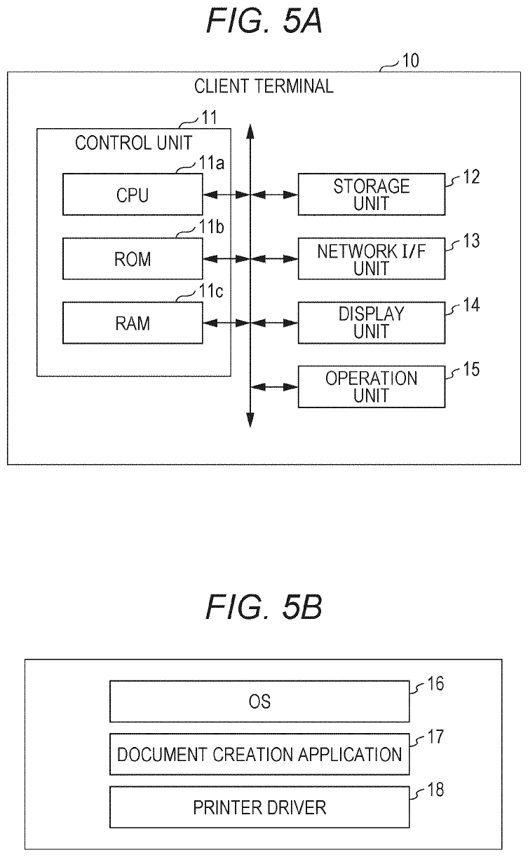

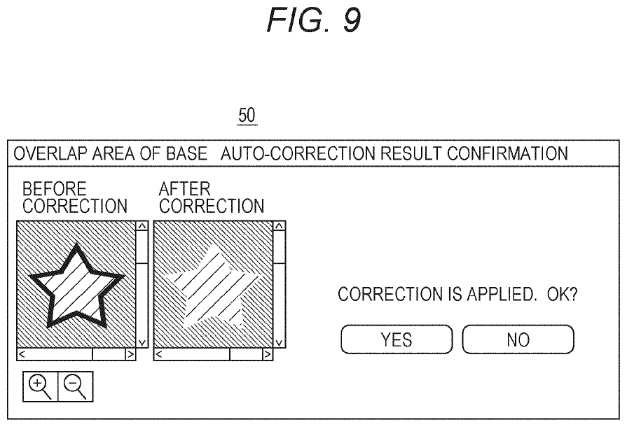

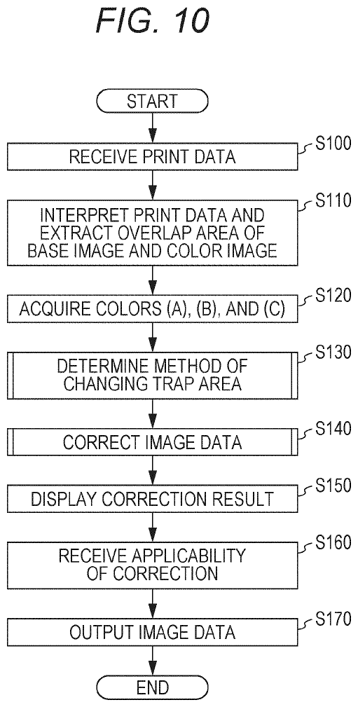

To describe the above-described embodiment of the present invention more in detail, an image processing method, an image processing apparatus, and an image processing program according to an example of the present invention will be described with reference to FIGS. 3 to 12. FIGS. 3 and 4 are schematic diagrams illustrating a configuration of a printing system according to the present example, and FIGS. 5A to 7 are block diagrams illustrating configurations of a client terminal, a controller, and a printer, respectively. Additionally, FIG. 8 is a schematic diagram that describes an overlap between a color image area and a base image area in a case of performing color printing on color paper, FIG. 9 is an exemplary screen displayed on the controller of the present example, and FIGS. 10 to 12 are flowcharts illustrating processing of the controller of the present example.

As illustrated in FIG. 3, in the printing system of the present example, a client terminal 10, a controller 20, and a printer 30 which can be connected via a communication network 40 are arranged individually on an intranet. As a standard of the communication network 40, Ethernet (registered trademark) or the like can be used, but IEEE 1394, Parallel, or the like can also be used for data transfer from the controller 20 to the printer 30, besides the Ethernet (registered trademark).

Note that the controller 20 and the primer 30 are illustrated as separate devices in FIG. 3, but the printer 30 may include the controller 20 as illustrated in FIG. 4. Hereinafter, the respective devices will be described in detail on the assumption of the configuration of FIG. 3.

[Client Terminal]

The client terminal 10 is a computer device such as a personal computer, and creates print data and transmits the same to the controller 20. As illustrated in FIG. 5A, the client terminal 10 includes a control unit 11, a storage unit 12, a network I/F unit 13, a display unit 14, an operation unit 15, and the like.

The control unit 11 includes a central processing unit (CPU) 11a and memories such as a read only memory (ROM) 11b and a random access memory (RAM) 11c. The CPU 11a controls operation of the entire client terminal 10 by developing and executing, in the RAM 11c, a control program stored in the ROM 11b or the storage unit 12. Additionally, as illustrated in FIG. 5B, an operating system (OS) 16, a document creation application 17, a printer driver 18, and the like are executed by the control unit 11 (CPU 11a).

The OS 16 includes Windows (registered trademark), a Mac OS (registered trademark), an Android (registered trademark), or the like, and makes the document creation application 17 and the printer driver 18 operable in the client terminal 10.

The document creation application 17 is software that performs text creation, spreadsheet calculation, image processing, and the like, whereby a color image and a base image can be created, settings for trapping can be performed, and the like. Furthermore, the printer driver 18 is read at the time of commanding printing, and data created by the document creation application 17 is transferred to the printer driver 18.

The printer driver 18 converts the data created by the document creation application 17 into print data in a language that can be interpreted by the controller 20 (data described in a page description language (PDL) such as a printer job language (PJL), a post script (PS), or a printer control language (PCL), or data in a portable document format (PDF)). The print data includes information regarding a color image and a base image, setting information for the trapping, and the like.

The storage unit 12 includes a hard disk drive (HDD), a solid state drive (SSD), or the like, and stores program for the CPU 11a to control each of the units, information related to processing functions of the apparatus itself, the data created by the document creation application 17, the print data created by the printer driver 18, and the like.

The network I/F unit 13 includes a network interface card (NIC), a modem, or the like, connects the client terminal 10 to the communication network 40, and transmits the print data to the controller 20.

The display unit 14 includes a liquid crystal display (LCD), an organic electroluminescence (EL) display device, or the like, and displays screens of the document creation application 17 and the printer driver 18, and the like.

The operation unit 15 includes a mouse, a keyboard, and the like, by which various kinds of operation can be performed, such as creation of a color image or a base image, setting for the trapping by the document creation application 17, and print commanding by the printer driver 18.

[Controller]

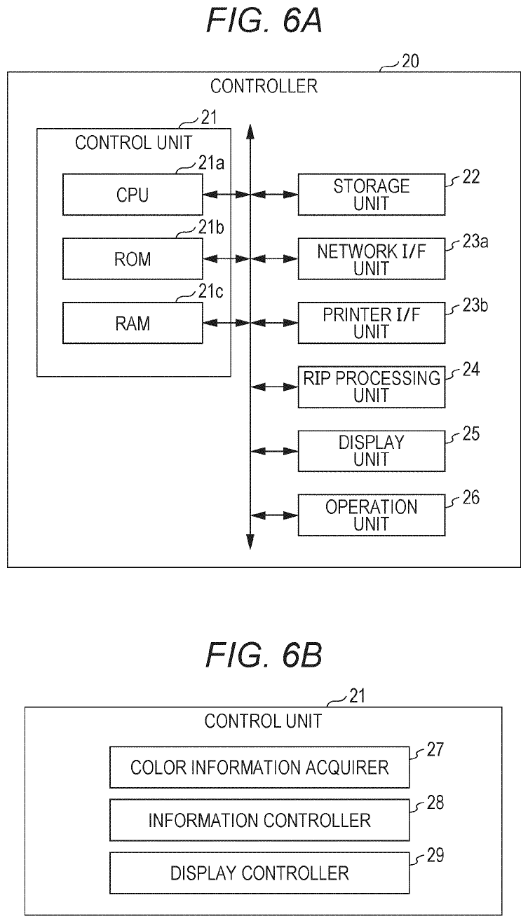

The controller 20 is an image processing apparatus that processes print data. As illustrated in FIG. 6A, the controller 20 includes a control unit 21, a storage unit 22, a network I/F unit 23a, a printer I/F unit 23b, a raster image processor (RIP) processing unit 24, a display unit 25, an operation unit 26, and the like.

The control unit 21 includes a CPU 21a and memories such as a ROM 21b and a RAM 21c, and the CPU 21a controls operation of the entire controller 20 by developing and executing, in the RAM 21c, a control program (including an image processing program) stored in the ROM 21b or the storage unit 22.

The storage unit 22 includes an HDD, an SSD, or the like, and stores: a program (including the image processing program) for the CPU 21a to control each of the units; the print data received from the client terminal 10; image data generated from the print data; an ICC profile used for color conversion; a correction LUT of the printer 30, and the like.

The network I/F unit 23a includes an NIC, a modem, or the like, connects the controller 20 to the communication network 40, and receives the print data and the like from the client terminal 10. The printer I/F unit 23b is a dedicated interface to connect the controller 20 to the printer 30, transmits image data and the like to the printer 30, and commands an outputting method.

The RIP processing unit 24 includes an image processing application specific integrated circuit (ASIC) and the like, analyzes the print data received from the client terminal 10, and generates pixel data in which a color image and a base image are arranged in accordance with the settings for trapping specified by the print data or determined by an area controller 28. Then, the image data is applied with processing in order to make a output object conform to a desired color (for example, color conversion processing using the ICC profile, color correction processing using the correction LUT, and the like) and outputs the data applied with the processing to the control unit 21.

The display unit 25 includes an LCD, an organic EL display device, or the like, and displays a correction result confirmation screen described later, and the like. The operation unit 26 includes a mouse, a keyboard, and the like, and receives a command for whether or not to correct the image data on the correction result confirmation screen. Note that the display unit 25 and the operation unit 26 may not be necessarily included in the controller 20, and may be included in, for example, a separate computer device that can be connected via a network so as to be operated in cooperation with the controller 20.

Furthermore, the control unit 21 controls the trapping. The control unit 21 functions as a color information acquirer 27, the area controller 28, a display controller 29, and the like as illustrated in FIG. 6B.

The color information acquirer 27 acquires color information regarding: a sheet; a base image (a first image formed with a first color material such as a white toner); and a color image (a second image formed with a second color material such as toners of C, M, Y, and K). Particularly, the color information acquirer acquires: the first color that is a color of the sheet; the second color that is a color obtained when the second image is formed on the sheet with the second color material; and a third color that is a color obtained when the second image is formed with the second color material on the sheet while forming, as a base, the first image with the first color material. Note that a method of acquiring the first color, the second color, and the third color is not particularly limited, and these colors may be acquired by measuring actually printed colors or may be acquired by calculation without performing the actual printing. In the former case, an image is formed on sheet by test printing or the like and measured by using an inline scanner or the like, or a chart image is separately generated and printed while setting corresponding colors in the image as measurement patches, and measured by using the inline scanner or the like. Furthermore, in the latter case, a theoretical value can be calculated by using printer profiles (a profile in a case of having a base and a profile in a case of having no base) or the like.

The area controller 28 enlarges or reduces an area of the second image protruding from the first image on the basis of the color information regarding the sheet, the first image (base image), and the second image (color image) acquired by the color information acquirer 27. For example, a case where a streak tends to be visually recognized at a boundary is determined on the basis of a relation between the first color, the second color, and the third color described above, and determines whether to enlarge or reduce the area in accordance with a determination result. Then, the area controller 28 corrects the image data so as to enlarge/reduce the area in cooperation with the RIP processing unit 24.

Specifically, a boundary line between the images is hardly visually recognized as a streak when brightness or saturation is gradually changed in the following order: a area of only the sheet, an area where only the color image is formed on the sheet (area formed with no base image), and an area where the base image and the color image are formed on the sheet. Therefore, similarly to normal trapping, the color image area is to be enlarged and/or the base image area is to be reduced. However, when a magnitude relation of the brightness or the saturation (particularly, the brightness) is inverted, the boundary line between the images tends to be visually recognized as a streak. Accordingly, the area is reduced in a case of satisfying at least one of following conditions.

a relation of brightness is the color (A)>the color (B)<the color (C).

a relation of saturation is the color (A)>the color (B)<the color (C), or the color (A)<the color (B)>the color (C). In other words, the color image area is reduced and/or the base image area is enlarged in a direction opposite to the normal trapping. At this time, in a case where print data (print data already applied with the trapping) in which the color image is set so as to protrude from the base image is acquired, the area is to be reduced from a current state. In a case where print data in which the color image is not set so as to protrude from the base image is acquired, the area is to be more reduced from the current state than when the relation of the brightness is the color (A)>the color (B)>the color (C) and the relation of the saturation is the color (A)>the color (B)>the color (C) or the color (A)<the color (B)<the color (C).

Here, in a case where a brightness difference or a saturation difference between the color (A) and the color (B) and those between the color (B) and the color (C) are large, the boundary line between the images tends to be more visually recognized as a streak. Therefore, the area may be reduced in a case of satisfying at least one of following conditions.

the relation of the brightness is the color (A)>the color (B)<the color (C) and the brightness difference between the color (A) and the color (B) or between the color (B) and the color (C) (a difference in L* in a CIELAB color space) is 10 or more.

the relation of the saturation is the color (A)>the color (B)<the color (C) or the color (A)<the color (B)>the color (C) and the saturation difference between the color (A) and the color (B) and the saturation difference between the color (B) and the color (C) are (a difference in C* in the CIELAB color space is) 15 or more.

Additionally, when the brightness difference or the saturation difference is small, the boundary line between the images is hardly visually recognized as a streak even though the magnitude relation of the brightness or the saturation is inverted. Therefore, in a case where both of the above-described conditions are not satisfied, the area may not be necessarily changed in a case of satisfying at least one of following conditions.

the relation of the brightness is the color (A)>the color (B)<the color (C) and the brightness difference between the color (A) and the color (B) and the brightness difference between the color (B) and the color (C) (the difference in L* in the CIELAB color space) are less than 10.

the relation of the saturation is the color (A)>the color (B)<the color (C) or the color (A)<the color (B)>the color (C) and the saturation difference between the color (A) and color (B) and the saturation difference between the color (B) and the color (C) are (the difference in C* the CIELAB color space is) less than 15.

Furthermore, when hue of the color (A) is far from hue of the color (B), the boundary line between the images tends to be visually recognized as a streak. Therefore, in a case where a hue difference between the color (A) and the color (B) is within a range of 180°±70°, a threshold of the brightness difference or the saturation difference may be set small (for example, the threshold of the brightness difference may be set to 6, the threshold of the saturation difference may be set to 9, and the like).

Note that, since it is generally said that a color difference is sensed when the brightness difference exceeds 6 and the saturation difference exceeds 9, the threshold of the brightness difference may be set to 6 and the threshold of the saturation difference may be set to 9. However, even when the color difference is sensed, the boundary line is not constantly visually recognized as a streak, and therefore, the threshold of the brightness difference is set to 10 and the threshold of the saturation difference is set to 15 while taking a margin (approximately 1.5 times). Furthermore, since the color difference is generally significant when the hue difference is 90° or more, in a case where the hue difference between the color (A) and the color (B) is 180°±90°, the threshold of the brightness difference or the saturation difference may be set small. However, depending on a combination of colors, there may be a case where the boundary line is noticeable, and therefore, in the case where the hue difference between the color (A) and the color (B) is 180°±70°, the threshold of the brightness difference or the saturation difference is set small (a value excluding the margin) while taking a margin.

Additionally, the brightness difference in the CIELAB space is used in the above description, but the determination can be made also by using a device value instead of the CIELAB space. For example, on the basis of a known calculation method in a YUV model or a YIQ model used in a phase alternating line (PAL) or a National Television System Committee (NTSC), a method of changing the area can be determined from whether or not a value V obtained from V=0.3×R+0.6×G+0.1×B exceeds 0.1 in a case where RGB values are indicated as values between 0 to 1.

Alternatively, the method of charming the area can also be determined from whether or not V obtained from V=0.3×(1−c)+0.6×(1−m)+0.1×(1−y) exceeds 0.1 in a case where CMYK values are indicated as values between 0 to 1. Here, note that following conditions are satisfied:

C=C×(1−K)+K;

M=M×(1−K)+K; and

Y=Y×(1−K)+K.

The display controller 29 displays, in a comparable manner on the display unit 25, an image based on the print data and an image applied with the correction of enlarging or reducing the area, and receives applicability of the correction (whether or not to execute the correction).

Note that the color information acquirer 27, the area controller 28, and the display controller 29 may be included as hardware, or an image processing program that causes the control unit 21 to function as the color information acquirer 27, the area controller 28, and the display controller 29 (particularly, the color information acquirer 27 and the area controller 28) may be provided, and the CPU 21a, may be made to execute this image processing program. Additionally, the control unit 21 is made to have the functions of the color information acquirer 27 and the area controller 28 here, but the RIP processing unit 24 may also be made to have the functions of the color information acquirer 27 and the area controller 28.

[Printer]

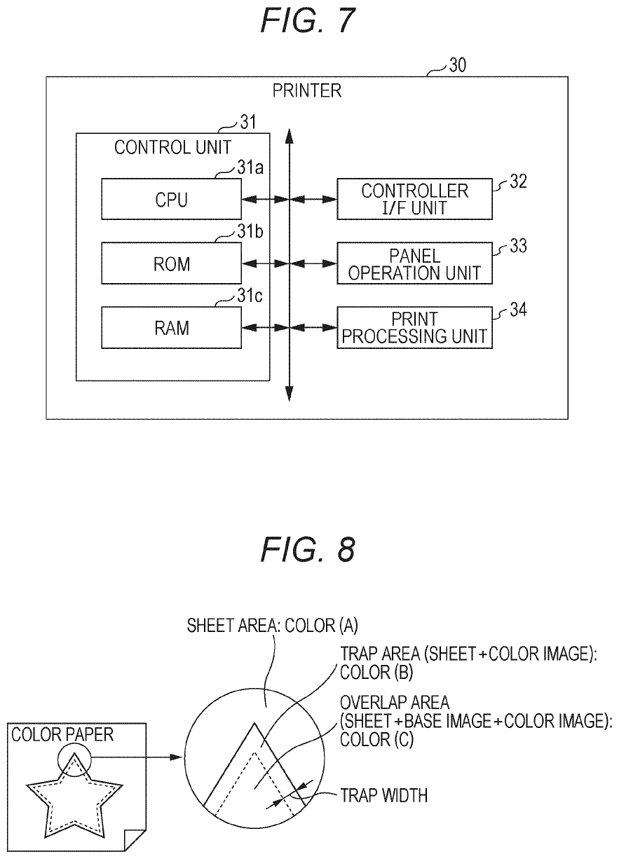

The printer 30 is a printing device such as an electrophotographic printer (in the present example, an electrophotographic printer capable of forming a CMYK color image on a white (W) base image in a single printing operation) and performs printing on the basis of a command from the controller 20. As illustrated in FIG. 7, the printer 30 includes a control unit 31, a controller unit 32, a panel operation unit 33, a print processing unit 34, and the like. Note that in a case of measuring and acquiring the color (A), the color (B), and the color (C), an inline colorimeter, an inline scanner, or the like may also be included.

The control unit 31 includes a CPU 31a to and memories such as a ROM 31b and a RAM 31c. The CPU 31a controls operation of the entire printer 30 by developing and executing, in the RAM 31c, a control program stored in the ROM 31b.

The controller I/F unit 32 is a dedicated interface to connect the printer 30 to the controller 20 and receives image data and the like from the controller 20.

The panel operation unit 33 is a touch panel or the like in which a touch sensor including a grid-like transparent electrode is formed on a display unit such as an LCD. The panel operation unit 33 displays various kinds of screens related to printing and enables various kinds of operation related to the printing.

The print processing unit 34 is a print engine that performs image forming on a sheet on the basis of the image data received from the controller 20. Specifically, a photosensitive drum electrically charged by a charging device is irradiated with light according to an image from an exposure device to form an electrostatic latent image. Then, a toner of each color electrically charged by a developing device is made to adhere to the electrostatic latent image and developed, the toner image is primarily transferred to a transfer belt, and secondarily transferred from the transfer belt to a sheet. Furthermore, processing of fixing the toner image on the sheet is performed at a fixing device. The print processing unit 34 may separately perform arbitrary correction in order to stabilize image formation.

Note that FIGS. 3 to 7 illustrate the exemplary printing system of the present example, and the configuration and control of each of the devices can be changed as appropriate. For example, the printing system of FIG. 3 is assumed in the above description, but in the case of the printing system of FIG. 4, the control unit 31 of the printer 30 may be made to have the functions of the color information acquirer 27, the area controller 28, and the display controller 29 (the CPU 31a of the control unit 31 may be made to execute the image processing program).

Hereinafter, operation of the controller 20 having the above-described configuration will be described. The CPU 21a executes processing of each of steps illustrated in flowcharts of FIGS. 10 to 12 by developing and executing, in the RAM 21c, the image processing program stored in the ROM 21b or the storage unit 22.

Note that, in the following description, a base image is formed on a sheet having the color (A), and a CIVIYK color image is formed thereon as illustrated in FIG. 8. A sheet area outside the color image has a color of the sheet, namely, the color (A), an edge area of the color image (an area not overlapping with the base image and referred to as a trap area) has a color (B) in combination of the sheet and the color image, and an area where the base image overlaps with the color image (referred to as an overlap area) has a color (C) in combination of the sheet, the base image, and, the color image. Additionally, an interval between an edge of the base image and an edge of the color image will be referred to as a trap width.

First, the controller 20 receives print data from the client terminal 10 or the like (S100). The print data is to have an arbitrary format such as a PS or a PDF that can be processed by the controller 20. Also, a data format of the color image and a data format of the base image included in the print data are also arbitrary. For example, the data may incorporate CMYK while treating the base as a spot color plate, or may be a combination of a plurality of files while separating a file of the base image from that of the color image. Furthermore, the print data may be data obtained after trapping or data obtained by adding, to data before the trapping, setting information for the trapping.

Next, the control unit 21 (RIP processing unit 24) interprets the print data, acquires image data for each of the colors including the base (in this case, each of W, C, M, Y; and K), and extracts an area (overlap area) where a white area and a color area have conformity of a predetermined degree or more (S110). Note that the overlap area can be extracted by using an arbitrary known method. At that time, only an area where the base image area and the color image area perfectly conform to each other may be extracted as described in JP 2016-096447 A. However, since there is a case where positions of objects are slightly deviated when the objects are arranged in an overlapping manner at the time of data creation by the computer, it is preferable to extract an area where the base image area and the color image area conform to each other with the conformity of the predetermined degree or more.

Next, the control unit 21 (color information acquirer 27) acquires the colors (A), (B), and (C) (S120). Each of the colors can be acquired by using an arbitrary known method, may also be acquired by measuring a color actually printed, or may also be acquired by calculation without performing the actual printing. In the former case, an image is printed by test printing and can be measured by using an inline scanner or the like, or a chart image is separately generated and printed while setting corresponding colors in the image as measurement patches, and measured by using the inline scanner or the like. In the latter case, a theoretical value can be calculated by using the printer profiles or the like.

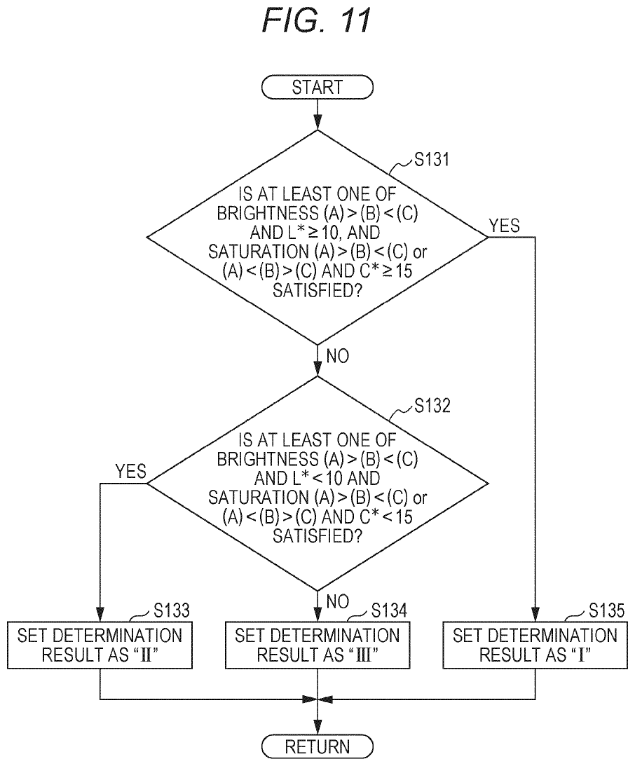

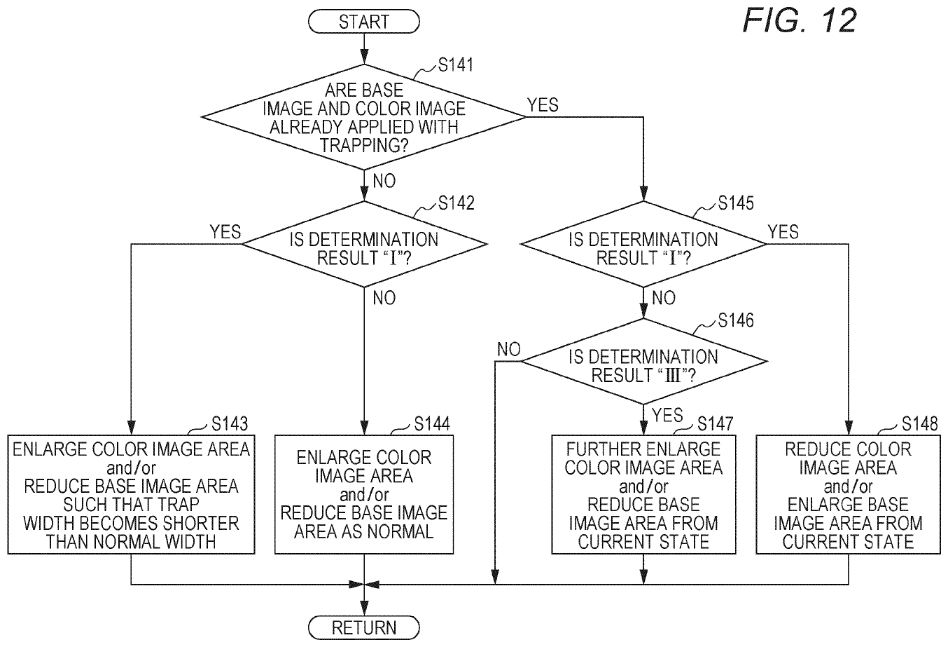

Next, the control unit 21 (area controller 28) sequentially determines, as for the colors (A), (B), and (C) acquired in the above-described step, whether or not the following relations are satisfied, and then determines a method of changing the trap area (S130). FIG. 11 illustrates details of this step, and it is first determined whether or not at least one of the following conditions is satisfied: a relation of brightness is the color (A)>the color (B)<the color (C) and a brightness difference L* is 10 or more; and a relation of saturation is the color (A)>the color (B)<the color (C) or the color (A)<the color (B)>the color (C) and a saturation difference C* is 15 or more (S131). In a case where at least one of the conditions is satisfied (Yes in S131), a determination result is set as “I” (S135). In a case where none of conditions is satisfied (No in S131), it is determined whether or not at least one of the following conditions is satisfied: the relation of the brightness is the color (A)>the color (B)<the color (C), and the brightness difference L* is less than 10; and the relation of the saturation is the color (A)>the color (B)<the color (C) or the color (A)<the color (B)>the color (C) and the saturation difference C* is less than 15 (S132). In a case where at least one of the conditions is satisfied (Yes in S132), a determination result is set as “II” (S133). Additionally, in a case where none of the relations is satisfied (No in S132), a determination result is set as “III” (S134).

Returning to FIG. 10, the control unit 21 (area controller 28) corrects image data by enlarging or reducing the trap area in accordance with the above-described determination result (S140). FIG. 12 illustrates details of this step, and it is first determined whether or not the base image and the color image are already applied with trapping (in other words, whether or not print data that has been set for the trapping is acquired) (S141). In a case where the base image and the color image are not yet applied, with the trapping (in other words, an edge of the base image and an edge of the color image substantially overlap with each other) (No in S141), it is determined whether or not the determination result is “I” (S142). In a case where the determination result is “I” (Yes in S142), the color image area is enlarged and/or the base image area is reduced such that a trap width becomes shorter than a normal width (S143). In a case where the determination result is “II” or “III” (No in S142), the color image area is enlarged and/or the base image area is reduced as normal (S144).

On the other hand, in a case where the base image and the color image are already applied with the trapping (in other words, the edge of the color image protrudes from the edge of the base image) (Yes in S141), it is determined whether or not the determination result is “I” (S145). In a case where the determination result is not “I” (No in S145), it is determined whether or not the determination result is “III” (S146). In a case where the determination result is “I” (Yes in S145), the color image area is reduced and/or the base image area is enlarged from the current state in a direction opposite to the normal trapping (S148). Additionally, in a case where the determination result is “III” (Yes in S146), the color image area is further enlarged and/or the base image area, is further reduced from the current state in a direction same as the normal trapping (S147). Furthermore, in a case where the determination result is “II” (No in S146), the area is not changed.

Returning to FIG. 10, the control unit 21 (display controller 29) displays a correction result of the image data (S150) and receives applicability of the correction (S160). For example, a correction result confirmation screen 50 is displayed on the display unit 25 as illustrated in FIG. 9 and a user determines whether or not to apply the correction. On the correction result confirmation screen 50, it is possible to compare the image based on the print data (the image before the correction) with the image applied with the correction of area enlargement or reduction (the image after the correction). Note that in a case where there is a plurality of areas that has been extracted/corrected, a list may be displayed or auxiliary information may be further displayed.

Then, the control unit 21 outputs the image data (S170). Specifically, in a case of applying the correction (in a case where “YES” is selected on the correction result confirmation screen 50 of FIG. 9), the corrected image data is transmitted to the printer 30 through the printer I/F unit 23b and printed. In a case of not applying the correction (in a case where “NO” is selected on the correction result confirmation screen 50 in FIG. 9), the image data before the correction is transmitted to the printer 30 through the printer I/F unit 23b and printed, and then the corrected image data is discarded. Here, note that in the case where “NO” is selected, the image data before the correction is output, but in the case where “NO” is selected, the processing may return to S130 so as to correct the image data by changing a condition.

Thus, since the settings for trapping (the direction of enlargement/reduction of the trap area, and the trap width) are changed on the basis of the relation between the colors of the sheet, the sheet+the color image, and the sheet+the base image+the color image, a printed matter having a preferable appearance can be easily created while avoiding the problem that a streak tends to be visually recognized at a boundary between the images.

Note that the present invention is not limited to the above-described example, and the configuration and the control can be modified as appropriate within the scope not departing from the gist of the present invention.

For example, the case where the base image is formed by using the white toner is exemplified in the above-described example, but the image processing method according to the embodiment of the present invention can be also similarly applied to a case where the base image is formed by using a non-white toner such as silver toner.

The present invention is applicable to an image processing method, an image processing apparatus, an image processing program, and a recording medium having the image processing program recorded therein in a system capable of forming a second image with a second color material on a sheet while forming, as a base, a first image with a first color material.

Although embodiments of the present invention have been described and illustrated in detail, the disclosed embodiments are made for purposes of illustration and example only and not limitation. The scope of the present invention should be interpreted by terms of the appended claims.

What is claimed is:

1. An image processing method in a system capable of forming a second image with a second color material on a sheet while forming, as a base, a first image with a first color material on the basis of print data,
the method comprising:
acquiring color information regarding the sheet, the first image, and the second image; and
enlarging or reducing an area of the second image protruding from the first image on the basis of the color information regarding the sheet, the first image, and the second image.

2. The image processing method, according to claim 1, wherein
the acquiring color information includes acquiring: a first color that is a color of the sheet; a second color that is a color obtained when the second image is formed with the second color material on the sheet; and a third color that is a color obtained when the second image is formed with the second color material on the sheet while forming, as the base, the first image with the first color material, and
the enlarging or reducing an area of the second image includes determining whether to enlarge the area or reduce the area on the basis of a relation between the first color, the second color, and the third color.

3. The image processing method according to claim 2, wherein
in a case where the print data in which the second image is set so as to protrude from the first image is acquired, the enlarging or reducing an area of the second image includes reducing the area in a case where a relation of brightness is the first color>the second color<the third color.

4. The image processing method according to claim 3, wherein
the enlarging or reducing an area of the second image includes reducing the area in a case where a relation of saturation is the first color>the second color<the third color, or the first color<the second color>the third color.

5. The image processing method according to claim 2, wherein
in a case where the print data in which the second image is not set so as to protrude from the first image is acquired, the enlarging or reducing an area of the second image includes more reducing the area in a case where the relation of the brightness is the first color>the second color<the third color than in a case where the relation of the brightness is the first color>the second color>the third color.

6. The image processing method according to claim 5, wherein
the enlarging or reducing an area of the second image includes more reducing the area in a case where the relation of the saturation is the first color>the second color<the third color, or the first color<the second color >the third color than in a case where the relation of the saturation is the first color>the second color>the third color, or the first color<the second color<the third color.

7. The image processing method according to claim 1, further comprising:
displaying, in a comparable manner, an image based on the print data and an image applied with correction of enlargement or reduction of the area; and receiving applicability of the correction.

8. The image processing method according to claim 1, wherein
the first color material includes a white toner.

9. The image processing method according to claim 1, wherein
the second color material includes toners of Y, M, C, and K.

10. An image processing apparatus in a system capable of forming a second image with a second color material on a sheet while forming, as a base, a first image with a first color material on the basis of print data,
the apparatus comprising
a hardware processor that:
acquires color information regarding the sheet, the first image, and the second image; and
enlarges or reduces an area of the second image protruding from the first image on the basis of the color information regarding the sheet, the first image, and the second image.

11. The image processing apparatus according to claim 10, wherein
the hardware processor acquires: a first color that is a color of the sheet; a second color that is a color obtained when the second image is formed with the second color material on the sheet; and a third color that is a color obtained when the second image is formed with the second color material on the sheet while forming, as the base, the first image with the first color material and
the hardware processor determines whether to enlarge the area or reduce the area, on the basis of a relation between the first color, the second color, and the third color.

12. The image processing apparatus according to claim 11, wherein
in a case where the print data in which the second image is set so as to protrude from the first image is acquired, the hardware processor reduces the area in a case where a relation of brightness is the first color>the second color<the third color.

13. The image processing apparatus according to claim 12, wherein
the hardware processor reduces the area in a case where a relation of saturation is the first color>the second color<the third color, or the first color<the second color>the third color.

14. The image processing apparatus according to claim 11, wherein
in a case where the print data in which the second image is not set so as to protrude from the first image is acquired, the hardware processor more reduces the area in a case where the relation of the brightness is the first color>the second color<the third color than in a case where the relation of the brightness is the first color>the second color>the third color.

15. The image processing apparatus according to claim 14, wherein
the hardware processor more reduces the area in a case where the relation of the saturation is the first color>the second color<the third, color, or the first color<the second color>the third color than in a case where the relation of the saturation is the first color>the second color>the third color, or the first color<the second color<the third color.

16. The image processing apparatus according to claim 10, wherein
the hardware processor displays, in a comparable manner, an image based on the print data and an image applied with correction of enlargement or reduction of the area, and receives applicability of the correction.

17. The image processing apparatus according to claim 10, wherein
the first color material includes a white toner.

18. The image processing apparatus according to claim 10, wherein
the second color material includes toners of Y M, C, and K.

19. A non-transitory recording medium storing a computer readable image processing program executed in an apparatus included in a system capable of forming a second image with a second color material on a sheet while forming, as a base, a first image with a first color material on the basis of print data,
the program causing the apparatus to execute:
acquiring color information regarding the sheet, the first image, and the second image; and
enlarging or reducing an area of the second image protruding from the first image on the basis of the color information regarding the sheet, the first image, and the second image.

20. The non-transitory recording medium storing a computer readable image processing program according to claim 19, wherein
the acquiring color information includes acquiring: a first color that is a color of the sheet; a second color that is a color obtained when the second image is formed with the second color material on the sheet; and a third color that is a color obtained when the second image is formed with the second color material on the sheet while forming, as the base, the first image with the first color material, and
the enlarging or reducing an area of the second image includes determining whether to enlarge the area or reduce the area on the basis of a relation between the first color, the second color, and the third color.
